(19) United States
(12) Patent Application Publication
(10) Pub. No.: US 2021/0380773 A1
(43) Pub. Date: Dec. 9, 2021

(54) METHOD FOR PRODUCING A REINFORCING MATERIAL AND REINFORCING MATERIAL

(71) Applicant: TEXTILCORD STEINFORT S.A., Steinfort (LU)

(72) Inventors: Bernhard MULLER, Baden (AT); Enrique HERRERO ACERO, Wien (AT); Sara VECCHIATO, Tulin (AT); Georg GUBITZ, Hart bei Graz (AT)

(21) Appl. No.: 16/322,744

(22) PCT Filed: Jun. 19, 2017
(86) PCT No.: PCT/EP2017/064971

§ 371 Date: Feb. 1, 2019

(30) Foreign Application Priority Data
Aug. 2, 2016 (DE) 10 2016 009 349.8

(51) Int. Cl. C08J 7/04; C08J 7/12; C08L 67/02; B60C 9/00

(52) U.S. Cl. CPC C08J 7/0427; C08J 7/12; C08L 67/02; C08L 2207/53; B60C 9/0042; C08J 2367/02; C08J 2421/00; B60C 9/005

(57) ABSTRACT

The invention relates to a method for producing a reinforcement material in the form of a core-shell structure, in particular of a tyre cord, wherein there is provided in a step a core having linear arrangements, in particular a cord-like core, wherein the linear arrangements have segments that are coupled to one another in a linear way by means of strength-increasing segment couplings, and wherein in a further step the core is provided with a shell by forming a core-shell coupling that increases adhesion, wherein segment couplings that are near to the surface are converted for the core-shell coupling.

The invention relates to a method for producing a reinforcement material for a rubber product in the form of a core-shell structure, wherein there is provided in a first step a core having linear arrangements, in particular a cord-like core, wherein the linear arrangements have segments that are coupled to one another in a linear way by means of strength-increasing segment couplings, and wherein in a second step a shell is applied to the core by forming a core-shell coupling that increases adhesion, as well as a corresponding reinforcement material and the uses thereof.

Such methods are applied, for example, in the production of textile reinforcement, in particular tyre cord. The part of the reinforcement material that is effecting reinforcement is essentially situated within the core, which may, for example, be a cord, which is formed from one or several multi-filaments, which are twined to one another. There are, however, known also various other constructions for the core, for example woven, knitted and warp-knitted structures. The multi-filaments may be various chemical fibres from synthetic polymers, wherein there are usually used high-strength fibres, with, however, also chemical fibres made from regenerated natural materials such as regenerate cellulosic fibres being used, as well as mixed or hybrid fibres made from two or more different fibre types.

Contemplating, for example, polymer fibres, the single filaments thereof represent linear arrangements, which are formed of a plurality of linear polymer chains, the monomers of which representing segments that are coupled to each other in a linear way, which are coupled via the functionality of the polymer chain they are based upon. These segment couplings provide for the structural integrity and, hence, also strength of the linear arrangements containing these. The segment couplings thus are the covalent bonds, via which the individual monomers are linked to one another along the longitudinal extension. Furthermore, stretching of the linear arrangements, which is known to those skilled in the art, contributes to the increase of strength upon the generation thereof, for example by way of a melt spinning method of the polymerized mass.

Reinforcement materials for rubber products are often subjected to high mechanical stress. In particular already during the production of the rubber product, i.e. for example during vulcanization, there will occur temperature-conditioned and/or mechanical stress. For this reason, linear arrangements having high strength as well as preferably also suitable shrinkage and creep characteristics are especially relevant. For this reason there are, for example, used polyester fibres, in particular polyethylene terephthalate fibres (PET fibres). PET fibres are available as classical high-strength fibres (high tenacity yarn), and also as HMLS-PET having established itself as a reinforcement fibre, e.g., for tyre cords. HMLS stands for “high modulus and low shrinkage”, and these fibres show good dimensional stability during the production process with temperature fluctuations and mechanical loads. The improved shrinkage characteristics in HMLS-PET are associated with an altered arrangement or distribution, respectively, of amorphous and crystalline areas in comparison to the high-strength PET fibres or amorphous PET materials.

The shell of the reinforcement material provides for the better insertion of the reinforcement material in the application case, e.g. in the production of tyres. For this purpose, there are used materials for the shell material, which may be well and rigidly connected with the rubber material of the intended application, in particular by way of vulcanization. Applying the shell onto the core is usually carried out by way of a so-called dipping method, wherein the core is immersed in a bath containing the shell material. For such a dip, there is, for example, used a resorcinol formaldehyde latex dip (RFL dip). Alternatively, there are described so-called RF-free dipping compositions needing no formaldehyde.

The core-shell coupling developing during the dipping method between the core and dip surrounding it as a shell, or the coupling strength thereof, respectively, is relevant for the quality of the reinforcement material, in particular tyre cords, and the products reinforced therewith. Thus, the reinforcement effect obtained with the core is only usable to its full extent if at the end there is a sufficient adhesion between the core and the matrix finally used in the application of the reinforcement material, in particular the rubber matrix.

For this reason, there have been developed methods according to this type in prior art in order to increase the adhesion effect of the core-shell coupling. The essential aspect of these methods is that they do not immediately immerse the core in the dip forming the shell but rather cover it in advance with an (intermediate) cover, for which there have been known two variants. On one side, there may be applied the (intermediate) cover in the course of a spinning process, namely by the fibre, in the course of the spinning process, being covered with a spinning finish containing in particular low-molecular epoxides. Such yarns may then be covered in the course of a single-bath immersion method with the resorcinol formaldehyde latex dip that forms the shell in a manner well known. One example of this is the HMLS multi-filament fibre 53×1 by Durafiber.

In another and predominating variant, the (intermediate) cover is obtained by the core being immersed in a pre-dip bath before covering with the RFL dip (and thus expanding the single-bath immersion method to a double-bath immersion method). The pre-dip may, for example, contain a mixture of blocked isocyanates and low-molecular epoxides, such as described in the Handbook of Rubberbonding, Brayon Crowether, Rappa Technology Ltd., 2003, p. 246. In both cases, the core-shell coupling mediated by the (intermediate) cover has a higher adhesion strength than that without (intermediate) cover, i.e. a direct core-shell coupling. By way of methods known, there are introduced new functionalities for a core-shell coupling via the (intermediate) cover. As there is added further material, these methods may result in an increase of weight compared to the untreated core material.

The invention is based on the task to improve methods according to the generic type for the production of reinforcement materials in particular in view of a simple handling and universal applicability.

This task is solved in regard to the method by way of a further development of the method of the type initially mentioned, which development is essentially characterized in that at least a part of the segment couplings that are near to the core surface are converted for the core-shell coupling. The method according to the invention comprises the following steps:

a) provision of an in particular cord-like core having linear arrangements, wherein the linear arrangements have segments that are coupled to one another in a linear way by means of strength-increasing segment couplings,
b) enzymatic conversion of the core, wherein segment couplings that are near to the core surface are cleaved at least in part,
c) application of a shell onto the core, wherein the core obtained in step b) is equipped with a shell.

In the context of the invention there has been realized that upon scarifying of at least a part of the strength-increasing segment couplings, thereby accepting the implied effect on the core, there may be used coupling material already present in the core for strengthening the core-shell coupling. The segment couplings are cleaved (broken up) for this conversion (refunctionalisation). Consequently, there will then be docking points available in the further step for the core-shell coupling. The docking points are functionalities, which are newly formed by cleaving the segment couplings.

In this way, there is created the possibility to omit the generation of the (intermediate) cover, and by omitting the formation of the (intermediate) cover and the method steps involved, there may be omitted, on the one side, a co-ordination of the sequential double-bath immersion method to this regard. On the other side, there may be omitted the spinning finish assigned to the spinning process and containing reactive compounds, in particular low-molecular epoxides. In this way there has been realized that in particular at the prevailing high spinning velocities of in part more than 5000 m/min there is prevented aerosol formation of low-molecular epoxides, which would otherwise prove to be nearly inevitable, which could have probably hazardous effects for the production staff.

Compared to a reference, wherein there is looked at an identically provided core with identically realized application of the shell, but without conversion of segment couplings that are near to the core surface, there is obtained an improvement of adhesion in the rubber product by at least 20%. Thereby it will suffice to convert preferably the segment couplings that are near to the core surface in one area on average not deeper than a radial depth of 50 n, also only up to 30 nm, even up to only 20 nm from the core surface.

Preferably in the conversion, segment couplings at a radial depth of more than 50 nm, in particular starting from a radial depth of 30 nm, are left predominantly intact. It would, certainly be possible to provide the surface structure of the core, by section-wise respectively deep transformations, with deep grooves, which could reinforce a mechanical coupling part of the core-shell coupling. However, such a reinforcement avoided in order to predominantly maintain structural integrity of areas of the cores that are remote from the surface or to prevent loss of strength, respectively, that would be involved otherwise. Due to surface areas that are more (amorphous areas) or less (crystalline areas) reactive to re-coupling, there cannot to be assumed an ideal uniform penetration depth of treatment; associated considerations thus and as far as quantitative specifications are indicated refer to average values.

Conversion is obtained by an enzymatic treatment of the core material. Suitable enzymes are in particular those ones that can cleave the segment coupling of the material of the linear arrangements in the core.

In other areas, in which polymer modification is of relevance, there has already been described the use of enzymes. For example, there are described enzymes in connection with the degradation or the recycling, respectively, of PET materials. In this regard, essentially all segment couplings are cleaved, and the polymer material will be completely cleaved into its segments. It has been known that the hydrolytic enzyme surface treatment of synthetic polymers may be used for some applications in order to improve the properties, such as by increasing hydrophilic properties, in particular in the textile field (Guebitz G. M., Cavaco-Paulo, A.: Enzymes go big: surface hydrolysis and functionalisation of synthetic polymers. Trends in biotechnology, Vol. 26, 2008 p. 32-38). There is, for example, described the use of cutinases for preventing undesired piling of polyester fibres, yarns and the textile fabrics produced therefrom (US 2007/0134799A1).

In an especially preferred embodiment of the method, the linear arrangements that are adjacent to one another have transverse couplings acting transversely to the linear extension thereof and obtained by stretching the linear arrangements upon the spinning thereof, which also promote strength (non-covalent interaction within a linear arrangement). In the experiments, there has been shown that with the fibres tested, the highly relevant characteristic of strength in a reinforcement material remains more or less unaffected by the fracture of the segment couplings. There is believed that this observation is based on the fact that in this embodiment, the transverse couplings are essentially less affected than the segment couplings cleaved for conversion. Hence, the method preferably provides a mild effect on the core in this regard. This mild effect is especially preferably obtained by the segment couplings being selectively cleaved, as the cleavage/conversion process is realized enzymatically. Herein it is relevant that enzymatic catalysts are highly specific for selected reactions and may thus selectively address the segment couplings to be cleaved. In this way, “harsh” (unspecific) effects may be prevented, which would also affect the transverse couplings to the same extent, which would, for example, occur by way of a brine attack such as caustic soda.

In an especially preferred embodiment of the method, the segment couplings are ester bonds.

In a preferred embodiment of the method, enzymatic cleaving is realized by way of hydrolytic cleavage. The enzymatic treatment is performed preferably by means of enzymes from the group of hydrolases. Hydrolases are assigned to the EC3 (enzyme class 3) according to the established enzyme classification system. In particular preferred are (EC3.1-) hydrolases.

In an especially preferred embodiment of the method, at least a portion of the docking positions is formed by respectively one carboxylic group. In this connection, in particular cutinases (E.C.3.1.1.74 carboxylic ester hydrolases) could be used for the enzymatic treatment. The invention, however, is not limited to this special form of enzymes. There may rather be used hydrolytic enzymes selected from the group consisting of proteases, lipases, cutinases, esterases or a combination of the same. A portion of the docking positions may also be formed by respectively one hydroxyl group.

In a preferred embodiment, the preferably hydrolytic cleavage of the segment couplings is accelerated by accelerating agents that are added, preferably by hydrophobins.

In regard to the segment couplings there is further preferred that at least one diol is selected from the group consisting of 1,2-ethanediol, 1,3-propanediol, 1,4-butanediol, 1,6-hexanediol, ethylene glycol, di(ethylene) glycol, tri(ethylene) glycol, poly(alkylene ether) glycol, poly(propylene ether) glycols and mixtures thereof.

There is further provided that at least one aromatic dicarboxylic acid or ester is selected from the group consisting of terephthalic acid, dimethyl terephthalate, isophthalic acid, dimethyl isophthalate, 2,6-naphthaline decarboxylic acid, dimethyl-2,6-dicarboxylic acid, dimethyl-2,6-naphthalate and mixtures thereof.

The linear arrangements thus comprise in a preferred embodiment a polyester, and the linear arrangement may, for example, comprise a polyester multi-filament. At least one polyester multi-filament may preferably be a twisted cord, in particular a cord made from polyethylene terephthalate (PET), preferably from HMLS-PET.

It will be appreciated that for the linear arrangements there are valid special requirements regarding material properties, as the reinforcement materials produced according to the inventive method are intended for rubber products under high stress. Accordingly, the materials provided for the core are different, for example, from fibres, which are intended for use in textiles. Hence, there is provided that the core has preferably at least one polyester multi-filament, the titre of which is preferably higher than 240 dtex, in particular higher than 400 dtex, and which has a breaking strength of more than 55 cN/tex, preferably more than 65 cN/tex.

While there is commonly aimed at a possibly low number of carboxyl groups as chain ends before the provision of the linear arrangement for the production of a reinforcement material, e.g., in the procedural production of polyester yarns, as these will lead to a thermally induced degradation reaction and, hence, in trend to a shortening of the polymer chain causing a deterioration of mechanical properties, in the method according to the invention there is aimed at increasing the carboxyl concentration in the region near to the core surface. In this regard, it is preferred that the carboxyl concentration (measured according to the Toluidine Blue O Method (TBO), described as in S. Rodiger et al, Analytische Chemie, 2011, 83, 3379-3385) compared with an untreated reference is higher by at least 0.03 nmol/mm², further preferred at least 0.04 nmol/mm², in particular at least 0.05 nmol/mm², even at least 0.6 nmol/mm². Furthermore there is preferred that the absolute carboxyl concentration of the enzymatically treated core is higher than 0.08 nmol/mm², further preferably higher than 0.1 nmol/mm², in particular than 0.12 nmol/mm², on the other side, however, lower than 3.5 nmol/mm², preferably lower than 3.0 nmol/mm², in particular lower than 2.5 nmol/mm². In this way there is achieved that the strength characteristics of the core will only be reduced in a practically hardly noticeable way.

In this connection there is alternatively or additionally provided that the weight loss involved with the enzymatic treatment (the cleavage of the segment couplings) of the core is merely insubstantial and in any case lower than 4% w/w, in particular lower than 3% w/w, even lower than 2.0% w/w.

Increasing adhesion of the core-shell coupling is thus realized by means of the increase of covalent bonds with the shell material achieved via the cleavage of the segment couplings, which is, for example, present in the form of the RFL dip or any other convenient shell material, i.e. that is accessible for such covalent bonds, which is in particular suitable for the vulcanization with the rubber products of the area of application selected.

Hence, it is conceivable to keep the residence time comparably long and to use suitably lower enzyme activities; but the residence time should preferably not exceed 72 h, preferably not exceed 48 h, and in particular not exceed 24 h. Especially preferred are, however, in particular rather short residence times of preferably less than one hour, in particular less than 30 min and also in the range of 5 min or less.

In this regard, there are preferably used process conditions, wherein the temperature of the enzymatic treatment is higher than 18°, preferably higher than 30° C., in particular preferably higher than 44° C. and preferably lower than 80° C., in particular preferably lower than 70° C., most preferably lower than 66° C. These will lead to a good balance between adhesion and strength.

In regard to the device, the invention provides a core for the reinforcement for a rubber product, wherein the core comprises linear arrangements, and the linear arrangements have segments that are coupled to one another in a linear way via strength-increasing segment couplings and the segment couplings are ester bonds, characterized in that the ester bonds that are near to the surface are cleaved at least in part, preferably hydrolysed.

In a further aspect the invention relates to a reinforcement material for a rubber product in the form of a core-shell structure having an in particular cord-like core having linear arrangements, which form in particular at least one polyester multi-filament, wherein the linear arrangements have segments that are coupled to one another in a linear way via strength-increasing segment couplings, with a shell having in particular a rubber material, which shell surrounds the core by an adhesion increasing core-shell coupling. The reinforcement material may have converted parts of segment couplings that are near the core surface and that are already contained during the provision of the core, such as carboxyl groups in order to form the core-shell coupling. The converted parts such as carboxyl groups are involved in the formation of the core-shell coupling, thus no longer detectable as such.

The advantages of the inventive core and the inventive reinforcement material are essentially the result of the above facts explained by way of the inventive method. This will also lead to preferred embodiments for the core and the reinforcement material from the embodiments preferred for the method.

In particular the core is obtained by a method comprising the following steps:

a) provision of an in particular cord-like core having linear arrangements, which comprise in particular at least one polyester multi-filament, wherein the linear arrangements have ester bonds as strength-increasing segment couplings of the segment that are coupled to one another in a linear way, and
b) enzymatic conversion of the core, wherein ester bonds that are near the core surface are cleaved at least in part.

There is further achieved a markedly improved adhesion behaviour by the reinforcement material in comparison to a reference material that is formed in the same way, apart from the treatment for conversion of the segment couplings that is not performed. In coverage percentage as determined according to ASTM D4393, this improvement amounts to at least 20%, preferably at least 50%, especially preferably even more than 100% and most preferably more than 300 or even 400%.

The reinforcement material according to the invention is also improved in regard to the “pull” determined according to ASTM D4393 in N/cm compared to the above defined reference material, wherein herein the improvement, measured in percent, is at least 10%, wherein also improvements of 20% are achieved, even improvements of 40% and higher.

These improvements are obtained, even though the strength of the core according to ASTM D76/D2256, greige cord deviates in relation to the reference material mentioned above by less than 5%, in particular less than 3% and even less than 2%. The strength properties of the core or the respectively formed reinforcement material, thus de facto remain at the respective values of the starting material for the core, when used in its initial construction, wherein, as usual, the absolute strength values depend greatly on the cord construction selected.

As already mentioned, the core of the reinforcement material has preferably at least one twisted polyester multi-filament.

The core may, however, also have further fibre ingredients, and it may, for example, be a hybrid cord, wherein the polyester multi-filament is combined with other filaments, which may be pre-immersed or not. There may be preferably used high-strength cellulose yarns as partners, for example having a strength oven-dried of higher than 35 cN/tex, preferably higher than 40 cN/tex; there may, however, also be used further polymer yarns, in particular further polyester multi-filaments from various polyesters as hybrid partners. There is preferably used for the contained polyester multi-filament a polyethylene terephthalate multi-filament, but also other polyester materials (PEN, PAN, PEE, PEF, PBO) are contemplated as well as contemplated as hybrid partners.

The polyester multi-filament may be combined, for example, also with a hybrid partner in the form of fibre material from polyketones, glass, steel, basalt or carbon. In an embodiment the core or the reinforcement material has a further fibre material with a material different from the linear arrangements and/or with a different structure.

The core in its shape is also not limited to a linear structure, for example a twisted cord. There is also provided that the core may be present in the form of a flat structure, for example of a fabric. For the formation of such a fabric, there may preferably be used a construction of a polyester cord and a different polymer cord or also cellulose cord, e.g., in a construction of 1×1. In one embodiment, the core or the core of the reinforcement material is a flat structure having the linear arrangements, in particular a fabric.

The invention further claims the use of such a core with segment couplings cleaved for conversion and a reinforcement material according to the aspects mentioned above for the reinforcement of rubber products (products having rubber structures), as well as such reinforced rubber products, which are not especially limited in their type and which may comprise, for example, carcass and belt bandage material, conveyor belts, hoses or even complete tyres.

The invention is explained in greater detail in the following by way of exemplary embodiments.

In the following exemplary embodiments (in the first step) for the provision of the core there is used a twisted cord of two polyethylene terephthalate multi-fibres. The carboxyl concentration of the untreated cord maximally detectable using the TBO method amounts to 0.07 nmol/mm².

In an intermediate step before the application of the dip forming the shell, the core is subjected to an enzymatic hydrolysis. For this purpose, there were used as enzyme in a first example cutinase 1 of Thermobifida cellulosilytica (native), in the following Thc_Cut1 (E. Herrero Acero et al. Macromolecules 2011, 44, 4632-4640), and in a second example the cutinase, also of Thermobifida cellulosilytica, but modified, namely a triple-mutant variant of Thc_Cut 2, in the following Thc_Cut2TM, with the mutations Arg19Ser, Arg29Asn and Ala30Val (E. Herrero Acero et al, Biotechnol. Bioeng. 2013, 2581-2590). The exact process in the intermediate step was as follows:

### Enzyme-Catalysed Hydrolysis with Thc_Cut1

10 m of a 1670×2 PET cord (Durafiber 50×1, 360 tpm) were fixed on a bobbin, washed with Triton X-100 (5 g L⁻¹), Na₂CO₃ (100 mM) and distilled water, and subsequently incubated in 400 ml phosphate buffer (100 mM, pH 7), containing 0.5 μM of Thc_Cut1, at 60° C. for 24 h. Following incubation, the cord was again washed with Triton X-100 (5 g L⁻¹), Na₂CO₃ (100 mM) and distilled water. According to EDA (energy-dispersive X-ray analysis), no more enzyme was detectable on the surface.

### Enzyme-Catalysed Hydrolysis with Thc_Cut2TM

10 m of a 1670×2 PET cord (Durafiber 50×1, 360 tpm) were fixed on a bobbin, washed with Triton X-100 (5 g L⁻¹), Na₂CO₃ (100 mM) and distilled water and then incubated in 400 ml phosphate buffer (100 mM, pH 7), containing 0.5 μM of Thc_Cut2TM, at 60° C. for 24 h. Following incubation, the cord was again washed with Triton X-100 (5 g L⁻¹), Na₂CO₃ (100 mM) and distilled water. According to EDA, no more enzyme was detectable on the surface.

The application of the shell in the further step was carried out by dipping into an RFL dip, for the first as well as for the second embodiment. More particularly, the core in the form of the cord resulting from the enzyme treatment in the intermediate step was dipped into a single-bath RFL dip having a total solid content of 22% that is common for rayon cord for at 18/min in a Labour-Single-End-Cord plant by C.A. Litzler Co., Inc. (Cleveland, Ohio) and crimped at 180° in the first oven and 230° in the second oven.

For the first and the second embodiment example, the coverage and the pull were determined according to ASTM D4393 for testing the adhesion strength. The results are presented in the following table 1 in relation to a zero reference, wherein the zero reference is a comparison example, wherein there has not been performed an enzymatic treatment but the core has only been exposed to the enzyme-free buffer solution for two hours.

TABLE 1

| | Coverage, related to the | Pull, related to the zero |
|---|---|---|
| Sample | zero reference | reference |
| Zero reference | 1 | 1 |
| Embodiment 1 | 2.5 (+150%) | 1.32 (+32%) |
| Embodiment 2 | 4.5 (+350%) | 1.53 (+53%) |

These significant improvements in adhesion are obtained by conversion of the segment couplings for the core-shell coupling, herein the PET-cord-dip coupling. This may also be verified in experiments in that the number of available docking points in the form of carboxyl groups is determined for the core of the zero reference and of the first and second embodiments. The determination of the level of carboxylation by means of the TBO method is used as a suitable measure for this purpose, and the level of carboxylation [nmol/mm²] (DoC) is determined, with details being given in the following:

### Determination of DoC by Means of TBO Method

The sample to be tested (approx. 1 g) was incubated in a 0.1% TBO solution in Tris/HCl buffer (100 mM, pH 8.6) for 15 min at 50° C. and 130 rpm (6 ml), then removed from the TBO solution and washed with Tris/HCl (100 mM, pH 8.6) until the wash solution was clear. The sample containing TBO was stirred with 20% SDS for 30 min at 50° C. and 130 rpm in order to release the TBO adhering to the carboxyls. The extinction at 625 n and 23° C. was measured in this solution. The carboxyl concentration (DoC) was calculated using the formula

DoC=(A*V)/(As*d*E)

A: absorption at 625 nm;
V: volume of the desorption solution [L];
As: PET surface [mm²] (in the case of cords, the area of the circular cylinder defining the cord
with the diameter of the cord was used).
d: optical path [cm];
ε: extinction coefficient of TBO [=54800 L mol⁻¹ cm⁻¹];
DoC: level of carboxylation [nmol/mm²]

The results are given in the following table 2.

TABLE 2

| Sample | DoC (nMol/mm²), TBO method |
|---|---|
| Zero reference | <0.07 |
| Embodiment 1 | 0.17 |
| Embodiment 2 | 0.29 |

By converting only segment couplings that are near to the surface into the core-shell coupling, no reduction in strength can be detected. For the zero reference as well as for the first and the second embodiment examples, the tenacity [N] greige cord according to ASTM D76/D2256 was determined and, as visible from the following table 3, there could not be detected any noticeable deterioration within the frame of measurement accuracy.

TABLE 3

| | Tenacity [N] greige cord (ASTM |
|---|---|
| Sample | D76/D2256) |
| Zero reference | 174.5 ± 2.97 |
| Embodiment 1 | 176 ± 0.96 |
| Embodiment 2 | 175 ± 0.8 |

Maintaining the mechanical properties is achieved in that in the intermediate step the segment coupling are selectively cleaved, while the structural integrity of the strength structure formed by the linear arrangements is largely unaffected. Thus, as to this aspect, there is applied a mild treatment in the intermediate step. If one attempted to perform a treatment using caustic soda (e.g., treatment with a 400 ml 0.5 NaOH solution for two hours at 50° C.) in the intermediate step, one would be able to reach a DoC in the range of the first or second embodiment, but rather with substantial loss in strength, which would be seen, on the one side, in a reduction of the tenacity within a relevant percentage range and, on the other side, in an impairment of the yarn structure of the core (pitting) that is detectable by means of SEM or AFM technology.

The invention is not limited to the features individually shown in the embodiments. The features of the subsequent claims and the preceding description may rather be relevant, individually or in combination, for the realization of the invention in the various embodiments thereof.

1. A method for producing a reinforcement material for a rubber product in the form of a core-shell structure, in particular of a tyre cord, wherein the method comprises the following steps:
a) providing a cord-like core having linear arrangements, wherein the linear arrangements have segments that are coupled to one another in a linear way by means of strength-increasing segment couplings,
b) enzymatically converting the core, wherein segment couplings that are near to the core surface are cleaved at least in part,
c) applying a shell onto the core, wherein the core obtained in step b) is equipped with a shell.

2. A method according to claim 1, wherein the segment couplings are ester bonds.

3. A method according to claim 2, wherein the linear arrangements comprise a polyester.

4. A method according to claim 1, wherein in step b) the temperature of the enzymatic treatment is higher than 18° C., preferably higher than 30° C., especially preferably higher than 44° C. and preferably lower than 80° C., especially preferably lower than 70° C., most preferably lower than 66° C.

5. A method according to claim 1, wherein in step b) the segment couplings that are near to the core surface are hydrolytically cleaved.

6. A method according to claim 1, wherein in step c) the core obtained in step b) is equipped with a shell material in a bath, preferably wherein there is applied a shell material comprising rubber.

7. A core for a reinforcement for a rubber product, wherein the core comprises linear arrangements, which comprise in particular at least one polyester multi-filament, and wherein the linear arrangements have segments that are coupled to one another in a linear way by means of strength-increasing segment couplings and wherein the segment couplings are ester bonds, characterized in that the ester bonds that are near to the surface are cleaved at least in part.

8. A core for a reinforcement according to claim 7, wherein the ester bonds that are cleaved in part and near to the surface are hydrolytically cleaved.

9. A core for a reinforcement according to claim 7, wherein the portion of the cleaved ester bonds is quantified by the level of carboxylation of the core and wherein said level of carboxylation is >0.08 nmol/mm², preferably >0.10 nmol/mm², especially preferably >0.12 nmol/mm².

10. A core according to claim 7, wherein the core has a relative strength of more than 95%, preferably more than 97%, especially preferably more than 98%, and wherein the relative strength is determined as ratio of the strength of the core to the strength of a reference core, wherein the reference core is a core without cleaved ester bonds and that has been formed otherwise in the same way, and wherein the strengths are determined respectively as tenacity greige cord according to ASTM D76/D2256.

11. A reinforcement material in the form of a core-shell structure having a core according to claim 7,
with a shell having a rubber material, which surrounds the core by a core-shell coupling that increases adhesion.

12. A reinforcement material according to claim 11, wherein the reinforcement material has a relative coverage improvement of at least 20%, preferably at least 50%, especially preferably at least 100%, wherein the relative coverage improvement C is determined by
C=(CT−CR)/CR,
wherein CT is the coverage for the reinforcement material and CR is the coverage of a reference reinforcement material, wherein the reference reinforcement material is formed in the same way, apart from a core without cleaved ester bonds, and wherein the coverage is respectively determined according to ASTM D4393.

13. A reinforcement material according to claim 11, wherein the reinforcement material has a relative pull improvement of at least 100%, preferably at least 200%, wherein the relative pull improvement C is determined by
P=(PT−PR)/PR,
wherein PT is the pull for the reinforcement material and PR is the pull of a reference reinforcement material, wherein the reference reinforcement material is formed in the same way, apart from a core without cleaved ester bonds, and wherein the pull is respectively determined according to ASTM D4393.

14. A method according to claim 2, wherein the linear arrangements comprise dicarboxylic acids and di-alcohols as segments that are coupled to one another in a linear way, which form a polyester.

15. A method according to claim 14, wherein the dicarboxylic acid segments are selected from 1,4-benzene dicarboxylic acid and 2,5-furan dicarboxylic acid and wherein the di-alcohol segments are 1,2-ethanediol.

16. A method according claim 2, wherein the linear arrangements comprise at least one polyester multi-filament.

17. A method according to claim 16, wherein the polyester multi-filament is a twisted cord, in particular a cord from polyethylene terephthalate (PET), preferably from HMLS-PET.

18. The core according to claim 7 incorporated as a reinforcement of rubber products, in particular as a carcass and belt bandage material or for conveyor belts or hoses.

19. A rubber product, in particular tyres, reinforced by a reinforcement material according to claim 11.
